(19) United States
(12) Patent Application Publication
(10) Pub. No.: US 2025/0269991 A1
(43) Pub. Date: Aug. 28, 2025

(54) ROTOR HUB WITH OFFSET TEETER AXIS

(71) Applicant: U.S. Army DEVCOM Army Research Laboratory, Adelphi, MD (US)

(72) Inventors: John W. Gerdes, Bel Air, MD (US); Hao Kang, Abingdon, MD (US); John T. Hrynuk, Joppa, MD (US); Elias J. Rigas, Newark, DE (US)

(21) Appl. No.: 18/587,575

(22) Filed: Feb. 26, 2024

(51) Int. Cl. B64U 30/297

(52) U.S. Cl. CPC B64U 30/297; B64U 2201/00

(57) ABSTRACT

A teetering rotor hub is described. The teetering rotor hub may be able to couple to multiple rotor blades and to a rotor. The teetering rotor hub may be associated with an aerial system. The teetering rotor hub may be able to rotate about a rotor spin axis of an associated motor. The teetering rotor hub may couple to the rotor or shaft. In some embodiments, the rotor hub may couple to a pair of rotor blades. The teetering rotor hub may be able to teeter along a second axis that is offset from the rotor spin axis, where the offset may be between zero and ninety degrees. By varying a speed signal provided to the rotor, the rotor blades coupled to the rotor hub may be moved in various ways to generate flapping motions that are able to control the direction of movement of the aerial system.

### GOVERNMENT INTEREST

The invention described herein may be manufactured, used and licensed by or for the U.S. Government.

### FIELD OF THE INVENTION

The invention relates to control of aerial systems.

### BACKGROUND OF THE INVENTION

Existing aerial systems may utilize complicated and expensive equipment such as a swashplate to achieve directional control of the aerial system via a rotor.

Thus, there is a need for ways to achieve directional control via a simplified rotor interface.

### BRIEF SUMMARY OF THE INVENTION

Some embodiments may provide a teetering rotor hub. The rotor hub may be able to couple to multiple rotor blades and to a rotor. The rotor hub may be associated with an aerial system.

The rotor hub may be able to rotate about a first axis that is parallel to a rotor spin axis of an associated motor. The rotor hub may couple to the rotor or shaft. In some embodiments, the rotor hub may couple to a pair of rotor blades.

The rotor hub may be able to teeter along a second axis that is offset from the first axis, where the offset may be between zero and ninety degrees.

By varying a speed signal provided to the rotor, the rotor blades coupled to the rotor hub may be moved in various ways to generate flapping motions that are able to control the direction of movement of the aerial system.

### BRIEF DESCRIPTION OF THE DRAWINGS

The novel features of the disclosure are set forth in the appended claims. However, for purpose of explanation, several embodiments are illustrated in the following drawings.

FIG. 1 illustrates a top plan view of a rotor hub of one or more embodiments described herein;

FIG. 2 illustrates a front elevation view of a rotor hub, in which the teeter axis is not offset relative to the z-axis;

FIG. 3 illustrates a front elevation view of a rotor hub of one or more embodiments described herein, in which the teeter axis is offset from the z-axis;

FIG. 4 illustrates a right-side elevation view of a rotor hub of one or more embodiments described herein, in which the rotor hub teeters along an offset teeter axis;

FIG. 5 illustrates a front elevation view of a rotor hub system of one or more embodiments described herein, in which the rotor hub is coupled to a motor;

FIG. 6 illustrates a right-side elevation view of a rotor hub system of one or more embodiments described herein, in which the rotor hub teeters about the offset teeter axis;

FIG. 7 illustrates an example overview of one or more embodiments described herein, in which a constant rotor speed is applied;

FIG. 8 illustrates an example overview of one or more embodiments described herein, in which a variable rotor speed associated with a first movement direction is applied;

FIG. 9 illustrates an example overview of one or more embodiments described herein, in which a variable rotor speed associated with a second movement direction is applied;

FIG. 10 illustrates a flow chart of an exemplary process that implements flight control via the rotor hub of one or more embodiments described herein; and

FIG. 11 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a rotor hub with an offset teeter axis. The offset teeter axis allows for operation without the use of a swashplate.

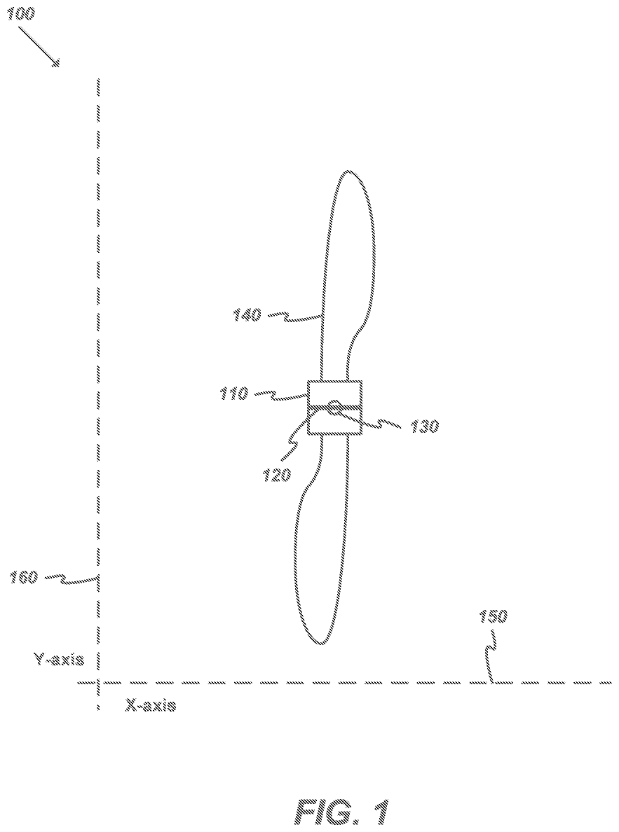

FIG. 1 illustrates a top plan view of a rotor hub 100 of one or more embodiments described herein. As shown, the rotor hub 100 may include a rotor hub hinge 110, a teeter axle 120, and a rotor coupling 130. In this example, the rotor hub 100 is coupled to a pair of rotor blades 140, but the rotor hub 100 may be coupled to various other sets of blades, propellers, and/or other appropriate components in any appropriate configuration and/or quantity.

Rotor hub 100 may be a mechanical device or component that is able to couple to a rotor (e.g., a cylindrical rotating member of a motor) via rotor coupling 130. Rotor hub 110 may be able to couple to rotor blades 140 and/or other appropriate components. Rotor hub 100 may include various appropriate components and/or elements in addition to, and/or in place of, those shown. For example, rotor hub 100 may include a housing or other enclosure. Rotor hub 100 may include various couplings or connectors that may allow the rotor hub 100 to interface with various rotors, rotor blades 140, and/or other appropriate components.

Rotor coupling 130 may include a shaft, axle, cylindrical cavity, and/or other appropriate components that may be coupled to a rotor. Rotor coupling 130 may include appropriate clamps, fasteners, adhesives, etc. as may be used to couple the rotor hub 100 to the rotor shaft.

Each rotor blade 140 may be any type of blade that is appropriate for the aerial system associated with the rotor hub 100. Such blades may be various sizes and/or shapes, include various different materials, have different interfaces or connectors, and/or include various features or attributes. In some cases, the rotor blades 140 may be fixedly coupled to the rotor hub hinge 110 such that the rotor blades 140 do not move relative to the rotor hub hinge 110.

X-axis 150 is parallel to the teeter axle 120 in this example. Y-axis 160 is perpendicular to x-axis 150. In this example, x-axis 150 and y-axis 160 may be perpendicular to a shaft or axle associated with rotor coupling 130 (and the associated rotor shaft).

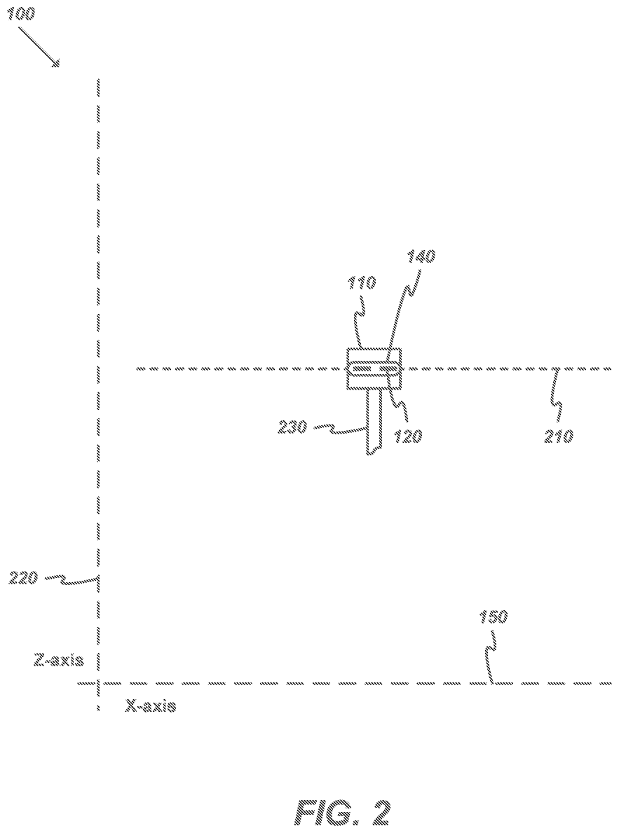

FIG. 2 illustrates a front elevation view of a rotor hub 100, in which the teeter axis 210 is not offset relative to the z-axis 220. The tip-path-plane of rotor blades 140 (i.e., the tip-path plane of the rotor blades 140 is parallel to teeter axis 210 and x-axis 150). The teeter axis 210 (or “lag-coupled” teeter axis) may run along a center or rotational axis of teeter axle 120. The tip-path-plane of the rotor blades 140 is perpendicular to a rotational axis of the motor rotating shaft 230 (included for clarity) in this non-offset configuration. Z-axis 220 may be perpendicular to x-axis 150 and y-axis 160. Z-axis 220 may be parallel to the rotational axis of the motor rotating shaft 230. If the teeter axis 210 is parallel to x-axis 150 and perpendicular to z-axis 220 as shown, this configuration is a typical teetering rotor where the hinge allows the blades to flap together in opposite directions like a seesaw.

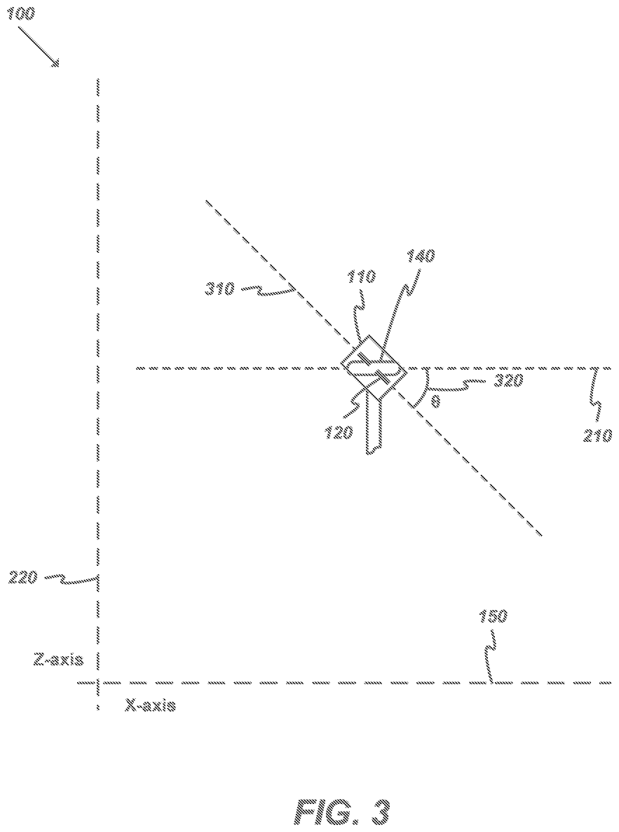

FIG. 3 illustrates a front elevation view of a rotor hub 100 of one or more embodiments described herein, in which the teeter axis 310 is offset relative to the z-axis 220. In this configuration, the tip-path-plane of the rotor blades 140 may remain parallel to the x-axis 150 and y-axis 160 (and non-offset teeter axis 210), while the offset teeter axis 310 may be offset from the non-offset teeter axis 210 (and x-axis 150) by some offset angle (θ) 320.

Offset, or lag-coupled, teeter axis 310 has a forty-five-degree offset angle (θ) 320 relative to non-offset teeter axis 210 (and x-axis 150 and z-axis 220) in this example. Offset angle (θ) 320 may be greater than zero degrees and less than ninety degrees.

Rotor hub hinge 110 may be a teetering hinge that is able to teeter about a teeter axle 120 or other rotating element that is offset from a plane defined by the path of rotors 140. Teeter axle 120 may be aligned with offset teeter axis 310 (or any other offset teeter axis having between zero and ninety degrees of offset), as shown in this example. Rotor hub hinge 110 may include various sets of sub-elements, such as axles or shafts (e.g., teeter axle 120), guides, stops, cavities or receptacles (e.g., a cylindrical cavity that receives a portion of a rotor), and/or other such elements that may provide rotational movement about one or more axes. Rotor hub hinge 110 may couple to a rotor via rotor coupling 130 such that the rotor hub hinge 110 may teeter across an offset axis (e.g., offset teeter axis 310) while rotating about the rotor axis of rotation.

Teeter axle 120 may include an axle, shaft, hinge, or similar element that allows the rotor hub hinge 110 to rotate about a teeter axis (e.g., offset teeter axis 310). Teeter axle 120 may include, utilize, and/or otherwise be associated with various elements, such as receptacles or cavities, guides, stops, etc., that may define the range of motion of the teeter axle 120 and the axis of rotation (e.g., offset teeter axis 310) relative to other components of the rotor hub 100.

Because of the incline of the lag-coupled teeter axis 310 out of the plane including x-axis 150 and y-axis 160 (and relative to z-axis 220), the teetering motion is augmented through a kinematic coupling between teetering (flapping) and azimuthal lag (where the “azimuthal” axis is parallel to z-axis 220 and may run along the rotational axis of motor rotating shaft 230. Due to the finite inertia of the rotor blades 140, any acceleration along the azimuthal axis must introduce a lag in the same direction, which will then couple into flapping motion as a function of the offset angle (θ) 320.

Practically, the result of the coupling described above is that the tip-plane-path of the rotor blades 140 may be pointed away from the z-axis 220 by varying the timing of azimuthal inertial loads (e.g., by varying the speed of rotation of rotor 220 throughout each rotation). By superimposing a sinusoidal velocity at the rotor frequency with a steady rotational velocity, a cyclic oscillation in blade flap may be achieved due to the sinusoidal lag motion of the rotor blades 140. The cyclic flap of the rotor blades 140 tilts the rotor blade tip-path-plane in some new direction offset from the x-axis 150 and/or y-axis 160, thus generating a component of the rotor thrust in the rotor hub plane including x-axis 150 and y-axis 160 and also moments on the rotor hub 100. These modified hub loads may be used to achieve altitude control for an aerial system (and/or other associated system, device, or set of components). By changing the magnitude of the superimposed sinusoidal velocity, the magnitude of the loads in the rotor hub plane can be adjusted. The direction of the hub forces and moments may be controlled by changing the phase of the sinusoidal velocity relative to the rotor hub 100 frame.

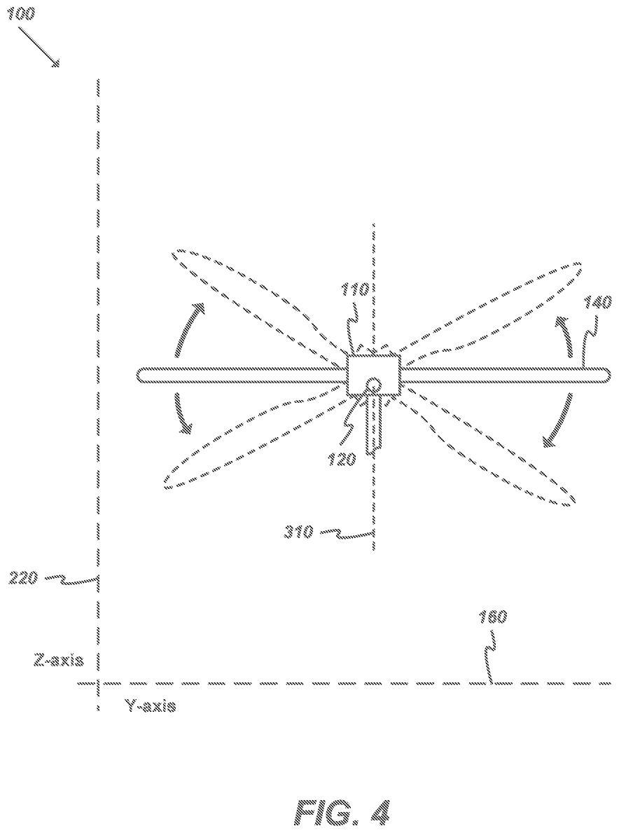

FIG. 4 illustrates a right-side elevation view of a rotor hub 100 of one or more embodiments described herein, in which the rotor hub 100 teeters about the teeter axle 120 along offset teeter axis 310 (e.g., a teeter axis having a forty-five-degree offset angle (θ) 320 running into the page). Z-axis 220 may be parallel to the rotational axis of the motor rotating shaft 230.

As shown, the rotor blades 140 may follow various tip-path-planes, in this example ranging from negative thirty to positive thirty degrees about offset teeter axis 310. Different embodiments may have different teetering ranges than shown (e.g., plus-minus forty-five degrees, fifteen degrees, etc.).

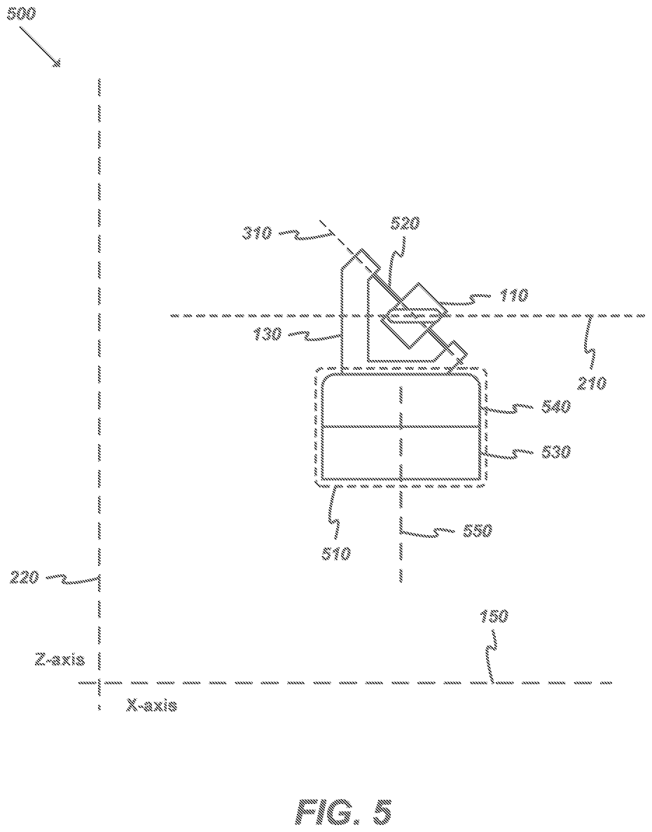

FIG. 5 illustrates a front elevation view of a rotor hub system 500 of one or more embodiments described herein, in which the rotor hub 100 is coupled to a motor 510. In this example, rotor hub 100 may include a rotor hub hinge 110 and a rotor coupling 130, as well as any or all other components described above.

Rotor hub system 500 may include rotor hub 100 and a motor 510. Rotor hub system 500 may be associated with an aerial system such as an unmanned aerial vehicle (UAV) or unmanned aerial system (UAS). The rotor hub system 500 may be coupled to a housing or exterior surface of the UAV or UAS (e.g., the top surface of a UAV), where such a surface may be parallel to the x-axis 150 and y-axis 160 in this example. Rotor hub system 500 may include various power couplings and/or communicative couplings that may allow the rotor hub system 500 to interact with an associated resource such as a UAV (e.g., by receiving power from the UAV, sending sensed or measured information to the UAV, etc.).

Rotor coupling 130 in this example may include a frame that couples to motor 510. The frame may have a modified “L” shape, with a horizontal member coupled to motor 510 and a vertical member that extends out from the horizontal member at a right angle as shown. Rotor coupling 130 may include a hinge coupling shaft 520 that is aligned with offset teeter axis 310. In this example, offset teeter axis 310 has an offset angle (θ) 320 of forty-five degrees relative to a non-offset teeter axis 210, where the offset angle (θ) 320 may be greater than zero degrees and less than ninety degrees. In this example, the rotor blades 140 may be mounted at a matching angle relative to the rotor hub hinge 110 (negative forty-five degrees in this example), as shown, such that the rotor blades 140 may follow a tip-path-plane parallel to non-offset teeter axis 210 when the rotor hub hinge 110 is angled as shown. Rotor hub hinge 110 may include a cylindrical cavity that is able to accept at least a portion of hinge coupling shaft 520 such that rotor hub hinge 110 is able to rotate about the hinge coupling shaft 520 (or offset teeter axis 310 as described above in reference to FIG. 4). Returning to the example of FIG. 5, the hinge coupling shaft 520 and cylindrical cavity may be components of the teeter axle 120.

Motor 510 may be a brushless motor that is able to change speeds very quickly. For example, speed changes may be synchronized with a rotation point relative to the rotor of motor 510 (e.g., rotation points differing by one-degree, one-half degree, etc.) and the rotor coupling 130 and associated rotor hub 100. Motor 510 may include a stationary motor portion 530 and a rotating motor portion 540. The stationary motor portion 530 may be fixedly coupled to an associated resource such as a UAV, test fixture, other non-moving substrate, etc. Rotating motor portion 540 may be able to rotate relative to stationary motor portion 530 about rotor axis 550. Rotor axis 550 may be parallel to z-axis 210 and may be aligned with a rotor of the motor 510 (e.g., motor rotating shaft 230), or a center point of a rotating portion of the motor 510 such as rotating motor portion 540. In this example, motor 510 may have a generally cylindrical shape and rotor axis 550 may be aligned with a center axis of the cylindrical shape. When powered, all components except for the stationary motor portion 530 rotate together about the vertically oriented rotor axis 550 (or “azimuthal” axis) of the motor.

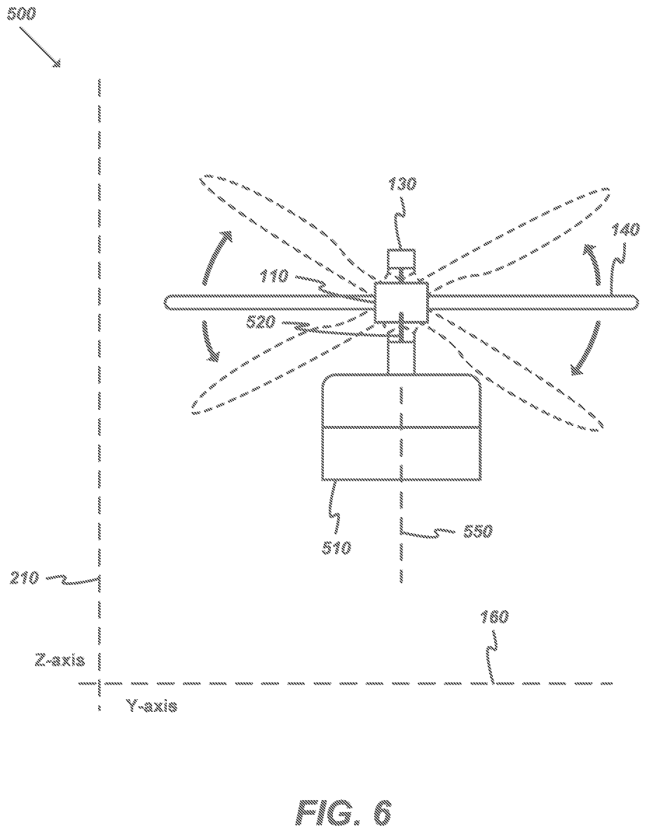

FIG. 6 illustrates a right-side elevation view of a rotor hub system 500 of one or more embodiments described herein, in which the rotor hub teeters about offset teeter axis 310, which is aligned with hinge coupling shaft 520 in this example. In this example, rotor hub hinge 110 is able to teeter plus/minus thirty degrees about the offset teeter axis 310.

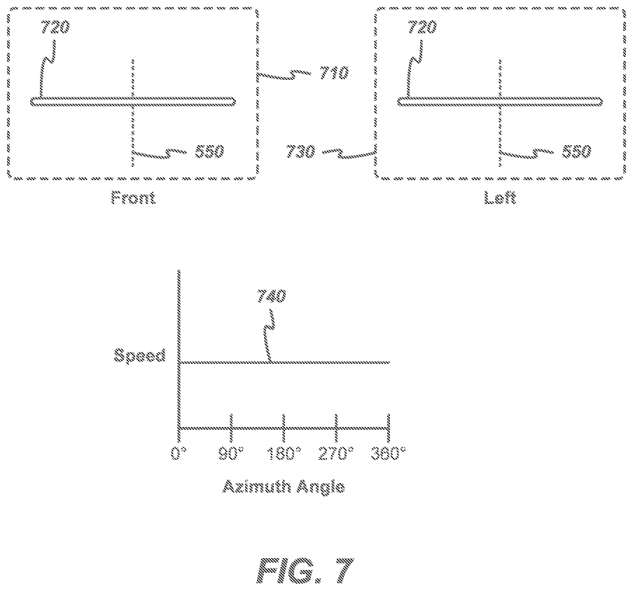

FIG. 7 illustrates an example overview of one or more embodiments described herein, in which a constant rotor speed is applied. When rotational velocity is constant, there is no lag force and centrifugal force keeps the tip-path-plane of the rotor blades 140 level, such as when a UAV hovers (or ascends or descends along a vertical axis).

Front elevation view 710 shows the tip-path-plane 720 of the rotor blades 140 as being perpendicular to rotor axis 550. Similarly, left-side elevation view 730 shows the tip-path-plane 720 of the rotor blades 140 as being perpendicular to rotor axis 550. Speed signal 740 shows a constant output level, where the speed signal 730 may be associated with a voltage or control signal applied to a motor (e.g., motor 510) and is represented over a full rotation about the rotor axis 550.

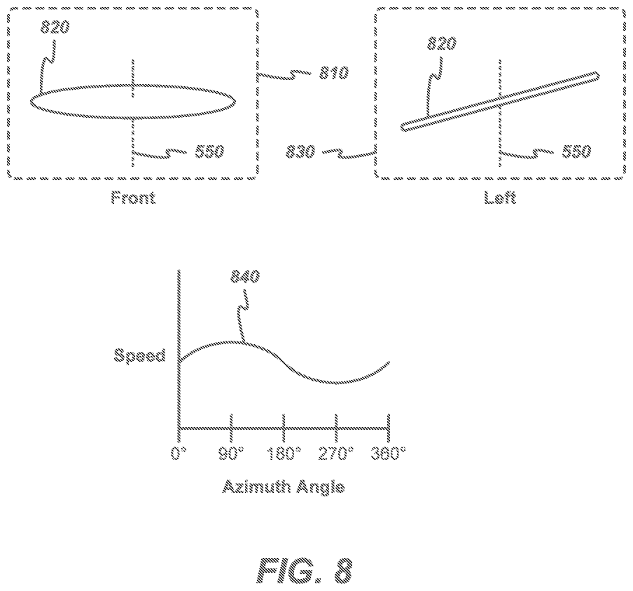

FIG. 8 illustrates an example overview of one or more embodiments described herein, in which a variable rotor speed associated with a first movement direction is applied. This example may be associated with forward movement (that may be coupled with increasing, decreasing, or constant altitude).

Front elevation view 810 shows the tip-path-plane 820 of the rotor blades 140 as flapping downward toward the front of an associated UAV or other platform and upward toward the rear of the associated UAV or other platform, such that forward motion is achieved. Left-side elevation view 830 shows the tip-path-plane 820 of the rotor blades 140 as being tipped forward relative to the UAV or other platform, resulting in forward speed (along the zero-degree azimuth angle position), Speed signal 840 includes the constant speed signal 740 and a superimposed sinusoid aligned with a one-hundred-eighty-degree rotational point (and zero-degree direction of movement relative to the azimuth angle and the UAV or other platform). The rotational point may be defined relative to a position of the rotor blades 140 during rotation about the rotor axis 550.

As shown, there is a clear offset between the rotor axis 550 and the tip-path-plane of the rotor blades 140 (fifteen degrees in this example). Thus, it is feasible to achieve directional control of a UAV or similar platform.

The flap deflection that arises from lag in the azimuthal direction is shown clearly. It is notable that the exact coupling angle between lag and flap is an adjustable feature of this design that arises from the magnitude of the angle between the lag-coupled teetering axis and the teeter axis.

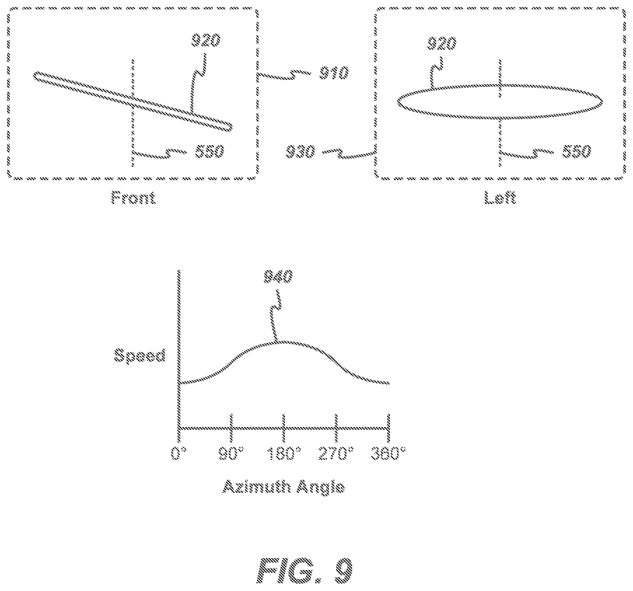

FIG. 9 illustrates an example overview of one or more embodiments described herein, in which a variable rotor speed associated with a second movement direction is applied. This example may be associated with rightward movement (that may be coupled with increasing, decreasing, or constant altitude),

Front elevation view 910 shows the tip-path-plane 920 of the rotor blades 140 as being tipped leftward relative to the UAV or other platform, resulting in rightward speed (along the two-hundred-seventy-degree azimuth angle position). Left-side elevation view 930 shows the tip-path-plane 920 of the rotor blades 140 as flapping downward toward the left side of an associated UAV or other platform and upward toward the right side of the associated UAV or other platform, such that rightward motion is achieved. Speed signal 940 includes the constant speed signal 740 and a superimposed sinusoid aligned with a ninety-degree rotational point (and two-hundred-seventy-degree direction of movement relative to the azimuth angle and the UAV or other platform). The rotational point may be defined relative to a position of the rotor blades 140 during rotation about the rotor axis 550.

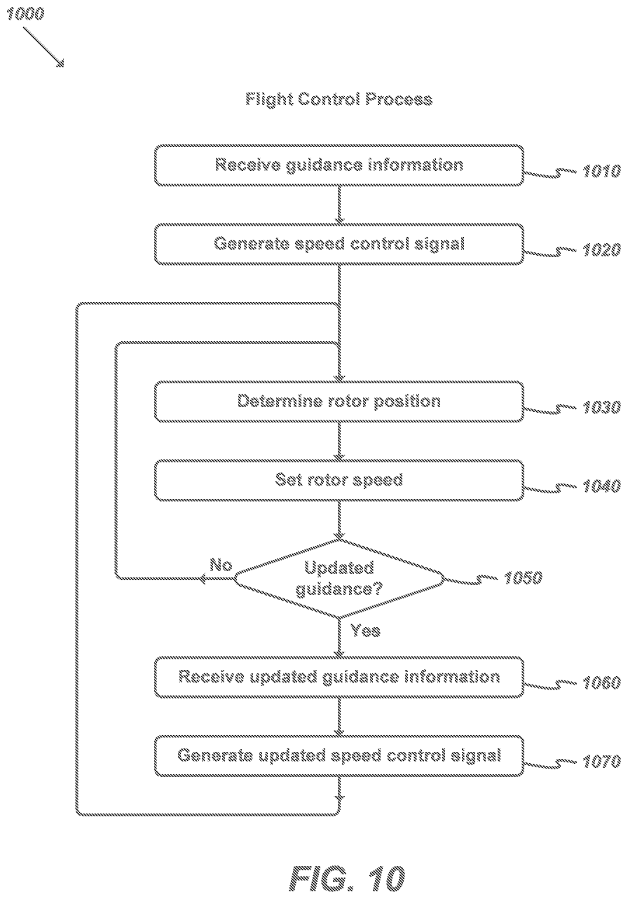

FIG. 10 illustrates an example process 1000 for implementing flight control via the rotor hub of one or more embodiments described herein. The process may be used to adjust motor speed to achieve desired movement of a UAV, UAS, and/or other appropriate device or platform. The process may be performed whenever a UAV, UAS, and/or other appropriate device is launched or otherwise takes flight. In some embodiments, process 1000 may be performed by a device such as device 1100 described below, via an element such as rotor hub 100 or rotor hub system 500.

As shown, process 1000 may include receiving (at 1010) guidance information. Guidance information may be received in various appropriate ways, in various appropriate formats, and from various appropriate resources. For instance, in some cases, a UAV or other platform may have communication capabilities with a server, remote pilot or operator, and/or other appropriate devices or systems. Guidance information may include, for instance, direction and speed information relative to a current position of the UAV. As another example, guidance information may include global positioning system (GPS) coordinates, and/or other such navigation coordinates that may define a target or destination. As another example, guidance information may include data received via a user interface (UI), such as a joystick or similar control. The UAV or other associated platform may include various positioning sensors or components that may be able to provide guidance information (e.g., GPS sensors, accelerometers, gyroscopes, altimeters, etc.).

Process 1000 may include generating (at 1020) a speed control signal. Based on the guidance information, the process may generate a speed control signal. Such a speed control signal may be similar to speed control signals 750, 850, or 950 described above. Generation of the speed control signal may include, for instance, determining a baseline or nominal rotational speed, as represented by speed control signal 750. Such a nominal rotational speed may be based on various relevant factors, such as environmental factors (e.g., wind speed and/or direction, temperature, etc.), weight and/or payload associated with the UAV or other platform, and/or other relevant factors. Perturbations to the nominal rotational speed, such as pulses, sinusoidal signals, and/or other appropriate signals may be generated based on factors such as a current position, destination, directional controls (e.g., joystick signals), and/or other relevant guidance information. In some embodiments, the speed control signal may be associated with a flight path, such that variations in direction, speed, and/or other attributes of movement may be automatically implemented as the UAV reaches each of a set of checkpoints. In some embodiments, a UAV or other platform may include sensors that may provide information relevant to speed control signal generation, such as environment sensors (e.g., temperature, humidity, etc.), force or stress sensors, etc.

The process may include determining (at 1030) a rotor position relative to an axis of rotation (e.g., a position from zero to three-hundred-sixty-degrees). The rotor position may be determined in various appropriate ways. For instance, in some embodiments, the rotor position may be provided by a resource such as motor 510 (and/or be derived from signals received from motor 510). In some embodiments, rotor hub 100 may include various position sensors and/or other similar elements that may be used to determine a rotor position.

As shown, process 1000 may include setting (at 1040) rotor speed based on the rotor position and the speed control signal information. The rotor speed may be set by applying the generated speed control signal for the current rotor position. For example, the generated speed control signal may include a value for each increment of rotation (e.g., one-degree, one-half degree, one-tenth degree, etc.) and the value for the current rotor position may be applied via a resource such as a motor driver interface.

Process 1000 may include determining (at 1050) whether updated guidance information is available. Such a determination may be made in various appropriate ways, depending on the type of guidance information available, sensors and/or other resources available, and/or other relevant factors. For instance, if the guidance information is provided as a destination having a set of GPS coordinates, an update message may be received from an external resource indicating a new destination with a different set of GPS coordinates, where such an update message may be identified as updated guidance information by the process. As another example, if the UAV associated with rotor hub 100 has moved more than a threshold distance since a last update, a new movement path may be calculated based on the destination location and current position. As another example, signals from a resource such as a joystick or other controller may be received at the UAV via a wireless communication link.

If process 1000 determines (at 1050) that updated guidance information is not available, the process may repeat operations 1030-1050 until the process determines (at 1050) that updated guidance information is available, or a target location is reached and/or other appropriate termination criteria are met.

If process 1000 determines (at 1050) that updated guidance information is available, the process may include receiving (at 1060) the updated guidance information. The updated guidance information may be received in a similar manner as the guidance information received at 1010.

As shown, process 1000 may include generating (at 1070) an updated speed control signal. The updated speed control signal may be generated based on the updated guidance information in a similar manner to the speed control signal generated at 1020.

Process 1000 may repeat operations 1030-1070 until the process determines that a target location has been reached and/or other appropriate termination criteria are met.

One of ordinary skill in the art will recognize that process 1000 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

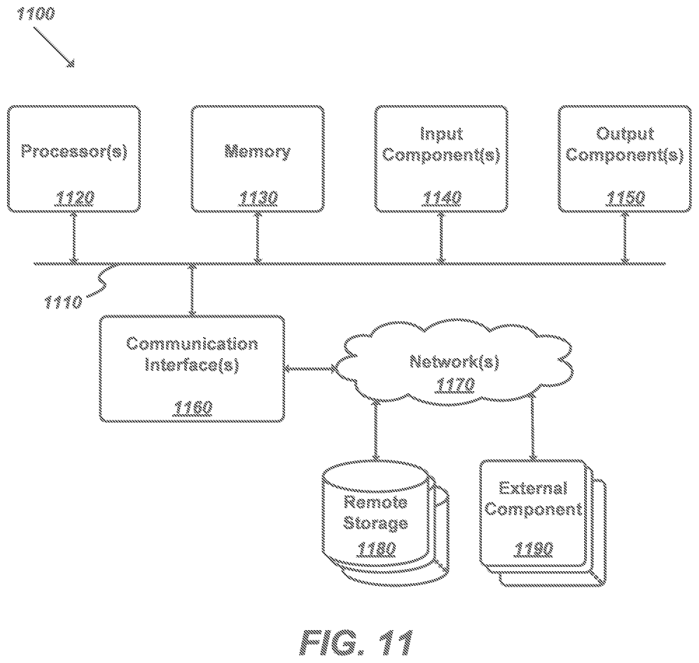

FIG. 11 illustrates a schematic block diagram of an exemplary device (or system or devices) 1100 used to implement some embodiments. For example, the systems, devices, components, and/or operations described above in reference to FIG. 1, FIG. 2, FIG. 3, FIG. 4, FIG. 5, FIG. 6, FIG. 7, FIG. 8, and FIG. 9 may be at least partially implemented using device 1100. As another example, the process described in reference to FIG. 10 may be at least partially implemented using device 1100.

Device 1100 may be implemented using various appropriate elements and/or sub-devices. For instance, device 1100 may be implemented using one or more personal computers (PCs), servers, mobile devices (e.g., smartphones), tablet devices, wearable devices, and/or any other appropriate devices. The various devices may work alone (e.g., device 1100 may be implemented as a single smartphone) or in conjunction (e.g., some components of the device 1100 may be provided by a mobile device while other components are provided by a server).

As shown, device 1100 may include at least one communication bus 1110, one or more processors 1120, memory 1130, input components 1140, output components 1150, and one or more communication interfaces 1160.

Bus 1110 may include various communication pathways that allow communication among the components of device 1100. Processor 1120 may include a processor, microprocessor, microcontroller, DSP, logic circuitry, and/or other appropriate processing components that may be able to interpret and execute instructions and/or otherwise manipulate data. Memory 1130 may include dynamic and/or non-volatile memory structures and/or devices that may store data and/or instructions for use by other components of device 1100. Such a memory device 1130 may include space within a single physical memory device or spread across multiple physical memory devices.

Input components 1140 may include elements that allow a user to communicate information to the computer system and/or manipulate various operations of the system. The input components may include keyboards, cursor control devices, audio input devices and/or video input devices, touchscreens, motion sensors, etc. Output components 1150 may include displays, touchscreens, audio elements such as speakers, indicators such as light-emitting diodes (LEDs), printers, haptic or other sensory elements, etc. Some or all of the input and/or output components may be wirelessly or optically connected to the device 1100.

Device 1100 may include one or more communication interfaces 1160 that are able to connect to one or more networks 1170 or other communication pathways. For example, device 1100 may be coupled to a web server on the Internet such that a web browser executing on device 1100 may interact with the web server as a user interacts with an interface that operates in the web browser. Device 1100 may be able to access one or more remote storages 1180 and one or more external components 1190 through the communication interface 1160 and network 1170. The communication interface(s) 1160 may include one or more application programming interfaces (APIs) that may allow the device 1100 to access remote systems and/or storages and also may allow remote systems and/or storages to access device 1100 (or elements thereof).

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1100 may perform various operations in response to processor 1120 executing software instructions stored in a computer-readable medium, such as memory 1130. Such operations may include manipulations of the output components 1150 (e.g., display of information, haptic feedback, audio outputs, etc.), communication interface 1160 (e.g., establishing a communication channel with another device or component, sending and/or receiving sets of messages, etc.), and/or other components of device 1100.

The software instructions may be read into memory 1130 from another computer-readable medium or from another device. The software instructions stored in memory 1130 may cause processor 1120 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A rotor hub comprising:
a rotor hub hinge that rotates about an offset teeter axis; and
a rotor coupling coupled to the rotor hub hinge,
wherein the rotor coupling is able to couple to a rotor that rotates about an azimuthal rotational axis, and
wherein the offset teeter axis is situated such that an offset angle between the azimuthal rotational axis and the offset teeter axis is between zero degrees and ninety degrees.

2. The rotor hub of claim 1, wherein the rotor hub is coupled to a pair of rotor blades.

3. The rotor hub of claim 1, wherein the offset angle is forty-five degrees.

4. The rotor hub of claim 1, wherein the rotor coupling comprises a frame with a horizontal member that is able to couple to a rotating portion of a motor and a vertical member that extends out from the horizontal member at a right angle.

5. The rotor hub of claim 4, wherein the rotor coupling further comprises a hinge coupling shaft that extends between the horizontal member and the vertical member at the offset angle relative to the horizontal member and the vertical member.

6. The rotor hub of claim 5, wherein the hinge coupling shaft couples to the rotor hub hinge via a cylindrical cavity running through the rotor hub hinge.

7. The rotor hub of claim 6, wherein an axis of rotation associated with the motor runs through the horizontal member.

8. An unmanned aerial system comprising:
a rotor hub comprising;
a rotor hub hinge that rotates about an offset teeter axis; and
a rotor coupling coupled to the rotor hub hinge,
wherein the rotor coupling is able to couple to a rotor that rotates about an azimuthal rotational axis, and
wherein the offset teeter axis is situated such that an offset angle between the azimuthal rotational axis and the offset teeter axis is between zero degrees and ninety degrees; and
a rotary motor comprising a stationary motor portion and a rotating motor portion, wherein the stationary motor portion is fixedly coupled to the unmanned aerial system and the rotating motor portion is coupled to the rotor coupling.

9. The unmanned aerial system of claim 8, wherein the rotor hub is coupled to a pair of rotor blades.

10. The unmanned aerial system of claim 8, wherein the offset angle is forty-five degrees.

11. The unmanned aerial system of claim 8, wherein the rotor coupling comprises a frame with a horizontal member that is able to couple to the rotating portion a vertical member that extends out from the horizontal member at a right angle.

12. The unmanned aerial system of claim 11, wherein the rotor coupling further comprises a hinge coupling shaft that extends between the horizontal member and the vertical member at the offset angle relative to the horizontal member and the vertical member.

13. The unmanned aerial system of claim 12, wherein the hinge coupling shaft couples to the rotor hub hinge via a cylindrical cavity running through the rotor hub hinge.

14. The non-unmanned aerial system of claim 13, wherein an axis of rotation associated with the motor runs through the horizontal member.

15. A method comprising:
receiving guidance information;
generating a speed control signal, wherein the speed control signal is associated with a rotor hub comprising:
a rotor hub hinge that rotates about an offset teeter axis; and
a rotor coupling coupled to the rotor hub hinge,
wherein the rotor coupling is able to couple to a rotor that rotates about an azimuthal rotational axis, and
wherein the offset teeter axis is situated such that an offset angle between the azimuthal rotational axis and the offset teeter axis is between zero degrees and ninety degrees; and
determining a rotor position; and
setting a rotor speed based on the rotor position and the speed control signal.

16. The method of claim 15 further comprising:
receiving updated guidance information;
generating an updated speed control signal;
determining the rotor position; and
setting the rotor speed based on the rotor position and the updated speed control signal.

17. The method of claim 15, wherein the offset angle is forty-five degrees.

18. The method of claim 17, wherein the rotor coupling comprises a frame with a horizontal member that is able to couple to the rotating portion a vertical member that extends out from the horizontal member at a right angle.

19. The method of claim 18, wherein the rotor coupling further comprises a hinge coupling shaft that extends between the horizontal member and the vertical member at the offset angle relative to the horizontal member and the vertical member.

20. The method of claim 19, wherein the hinge coupling shaft couples to the rotor hub hinge via a cylindrical cavity running through the rotor hub hinge.
